(19) United States
(12) Patent Application Publication
(10) Pub. No.: US 2003/0149907 A1
(43) Pub. Date: Aug. 7, 2003

(54) Method and apparatus for uplink clock extraction in a communication system

(76) Inventors: Chandra Mauli Singh, Ottawa (CA); Mohammad Akhter, Kanata (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 10/327,871

(22) Filed: Dec. 26, 2002

Related U.S. Application Data
(60) Provisional application No. 60/342,126, filed on Dec. 26, 2001.

(51) Int. Cl. G06F 1/04

(52) U.S. Cl. 713/500

(57) ABSTRACT

A system and method of uplink clock extraction, particularly in a satellite communication system. Jitter and sideband suppression and compensation are employed to provide an all digital method and system. A simple implementation is available using only digital components and a corresponding timing recovery algorithm. This system can operate in the absence of a timing stamp which provide better bandwidth conservation.

This application claims the benefit of priority from U.S. Provisional Application No. 60/342,126 filed on Dec. 26, 2001.

### FIELD OF THE INVENTION

The present invention relates generally to extracting a clock signal in a communications system. More particularly, the present invention relates to a method and apparatus for extracting the clock signal in an uplink communications channel.

### BACKGROUND OF THE INVENTION

Satellite communication systems, can be viewed as point to point communication channels between terrestrial and space-borne nodes. In some embodiments the channels may also be between two terrestrial nodes or two space-borne nodes. In satellite communication systems, both the payload and the local oscillator suffer from various timing errors such as drift and clock jitter. Moreover, local and payload oscillators are typically non-coherent. One of the most important tasks of the baseband demodulator is locking on to the payload clock which is extracted from the downlink signal received from the payload. Once clock recovery is performed, the demodulator should generate the required reference frequencies for the AT.

To meet the uplink frequency accuracy, the terminal typically reduces the jitter in the recovered clock. In many cases, clock jitter is expressed in the frequency domain as phase noise. Therefore, reducing the jitter reduces the phase noise. In addition to compensating for the terminal oscillator error, payload reference oscillator error, and the downlink phase noise, the Doppler shift related events must be compensated for in the uplink frequency. Moreover, the uplink frequency should arrive at the baseband input to the payload demodulator with a frequency error of no more than 130+2v Hz, where, v is the error in the satellite velocity estimate in m/s. One skilled in the art will appreciate that 130 Hz selected as the constant term to represent the sum of the mean and 3σ of the random frequency error, where, σ denotes the standard deviation.

To maintain overall timing in the satellite communications channel, a highly accurate reference clock that is locked to the transmitter clock is required. In many satellite systems, the clock signal is extracted by the detection of time stamp blocks, or through the recovery of an analog symbol timing recovery block.

In reference to the required uplink frequency correction and the out-door unit (ODU) reference frequency generation methods in a terminal, existing solutions requires a timing stamp from the transmitter or an analog timing recovery algorithm to extract a highly accurate clock locked to the transmitter. Additionally an algorithm to remove the jitter from the recovered clock is required.

Further information on this topic may be found in the following two references: Nee R. V. and Prasad R., OFDM for Wireless Multimedia Communications. Artech House, 2000; and M. Hsieh and C. Wei, “A Low complexity Frame Synchronization and Frequency Offset Compensation Scheme for OFDM Systems over Fading Channels,” IEEE Trans. on Vehicular Technology, Vol. 48, No. 5, September 1999.

It is, therefore, desirable to provide a method of Uplink Clock Extraction, and an apparatus for same.

### SUMMARY OF THE INVENTION

It is an object of the present invention to obviate or mitigate at least one disadvantage of previous methods and apparatuses for uplink clock extraction.

In a first aspect, the present invention provides a method of extracting a reference clock signal from a received analog signal. The method comprises digitising the received analog signal with a sampling rate determined by a sampling clock signal. Timing signals are then recovered from the digitised signal to produce a sample skipping signal, and the sample skipping signal is gated with the sample clock signal. The reference clock signal is then generated through analog synthesis of the gated signals.

In presently preferred embodiments, the method includes filtering the digitised signal prior to recovering the timing signals. This filtering can include applying a square-root-raised-cosine filter to the digitised signal. The method can also include digitally cleaning the generated reference clock signal to remove jitter, where digitally cleaning includes determining an error signal representative of the digitally determined phase difference between a controlled clock signal and the generated reference clock signal; adjusting an oscillator controlling the controlled clock signal to reduce the phase difference between the controlled clock signal and the received clock signal without introducing jitter in the controlled signal; and providing the controlled clock signal as the extracted reference clock signal.

In further embodiments, the error signal determination includes incrementing the position of a write pointer in a circular array with every tick of the generated reference clock signal; decrementing the position of a read pointer in a circular array with every tick of the controlled clock signal; and generating the error signal based on the difference in the read and write pointers.

In a further aspect, the present invention provides a clock signal extractor for receiving an analog signal from a remote station and generating a reference clock signal representative of the clock of the remote station. The extractor comprises a sampling clock, for generating a sampling clock signal; a digitiser, for receiving the analog signal from the remote station and digitising it at a sampling rate determined by the sampling clock signal; a timing symbol recovery unit, for receiving the digitised signal and for generating a sample skipping signal based on the digitised signal; a gate for gating the sample skipping signal and the sampling clock signal; and an analog synthesis unit for generating the reference clock signal based on the gated signal.

In preferred embodiments of the system, the extractor includes a filter for receiving the digitised signal, and providing the timing symbol recovery unit with a filtered digitised signal. The filter can be, for example, a square root raised cosine filter. Preferably, the analog synthesis unit includes a phase detector for detecting the phase difference between the gated signal and a reference signal produced by a controlled oscillator, and for deriving an error signal representative of the difference; a filter, for receiving the error signal from the phase detector, and adjusting the controlled oscillator to reduce the difference between the gated signal and the reference signal; and the oscillator, for providing the reference signal as the extracted clock reference signal. Typically, the oscillator is a numerically controlled oscillator.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a block diagram of a reference clock generator;

FIG. 2 illustrates a Symbol clock generator;

FIG. 3 illustrates the timing of signals used in the reference clock generator;

FIG. 4 illustrates a Jitter cleaner; and

FIG. 5 illustrates the operation of the write pointer upon receiving a clock signal.

### DETAILED DESCRIPTION

Generally, the present invention provides a method and system for uplink clock extraction, particularly in a satellite communication system. The present invention, when deployed in a satellite communications system, requires an estimate of the Doppler frequency shift. One skilled in the art will appreciate that a number of techniques known in the art can be used can be used to derive the Doppler estimate. One such technique derives a Doppler shift estimate based on ephemeris data from the baseband modem.

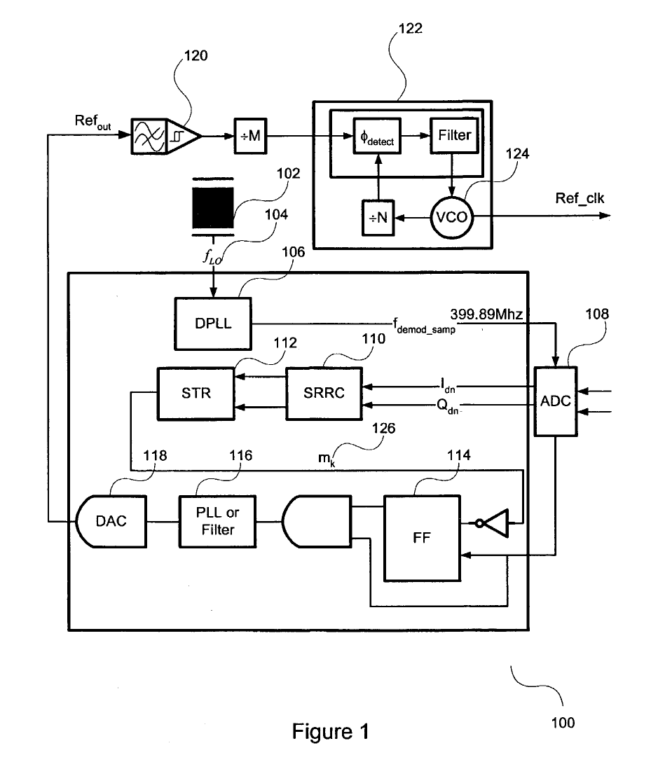

FIG. 1 illustrates the architecture used to generate a reference clock 100. Reference clock 100 includes local oscillator 102 having output f_{LO} 104, a digital phase-locked loop (DPLL) 106, an analog to digital converter (ADC) 108, a received matched square root raised cosine (SRRC) filter 110, an symbol timing recovery (STR) block 112, a clock extraction block 114, a bandpass filter or phase-locked loop(PLL) 116, a digital to analog converter (DAC) 118, Schmitt trigger 120 and an analog synthesizer 122 with a voltage controlled crystal oscillator (VCO) 124.

The clock extraction circuit 114 is provided with the I and Q samples from ADC 108 which is driven by a local oscillator 102. The I and Q samples are also passed through receiving SRRC filter 110 and passed through an all STR 112. STR 112 is preferably all digital. The sample skipping signal, mₖ 126, wich is the output of STR 112 is then gated with the sample clock and passed through band pass filter or PLL 116. The output of PLL 166 is then passed through an analog synthesizer 122 to generate a clock, locked to transmitted signal with very good phase noise performance. In a presently preferred embodiment, ref_clk, the output of analog synthesizer 122 has a frequency of double the symbol rate.

The present invention, as described above, has the numerous advantages, including a very accurate extracted clock that has very good phase noise performance, and is locked to the transmitter. A simple implementation is available using only digital components and a corresponding timing recovery algorithm. This system can operate in the absence of a timing stamp which provide better bandwidth conservation. The clock extraction method discussed above could be used in any communication system requiring an accurate reference clock.

The present invention provides a method for extracting an accurate reference clock in communication systems based on an all digital timing recovery algorithm. Thus, the reference clock extraction based on the symbol timing recovery loop is an all digital implementation.

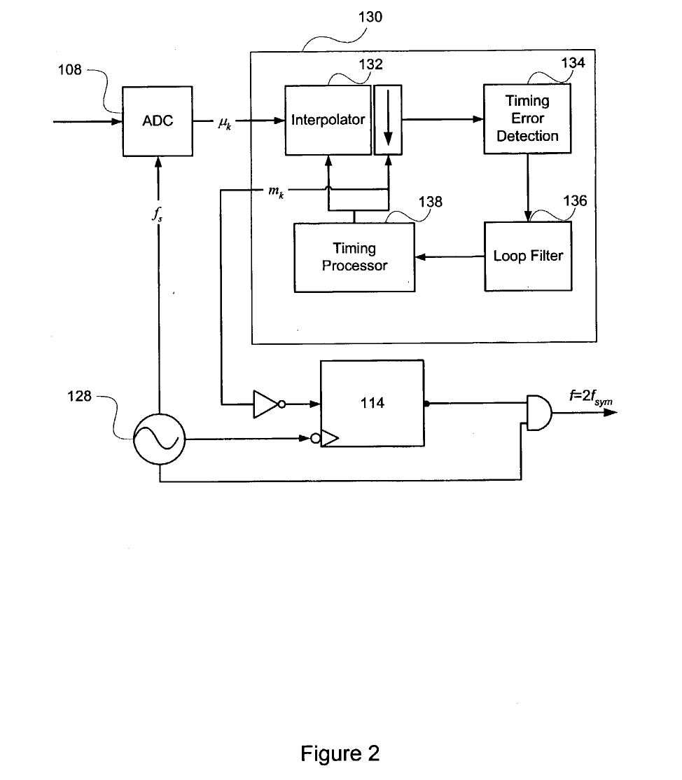

FIG. 2 provides an architectural overview of the system of the present invention. ADC 108 is driven by free running clock 128 which has output fₛ. ADC provides it output, μₖ, to timing recovery (TR) loop 130. TR loop 130 includes interpolator 132, timing error detection 134, a loop filter 136 and a timing processor 138. Interpolator 132 receives μₖ, from ADC 108 and mₖ, from timing processor 138, while providing its output to timing error detection 134. Loop filter 136 receives the output of timing error detection 134 and provides its output to timing processor 138. Timing processor 138 provides mₖ, which is used as the output of TR loop 130.

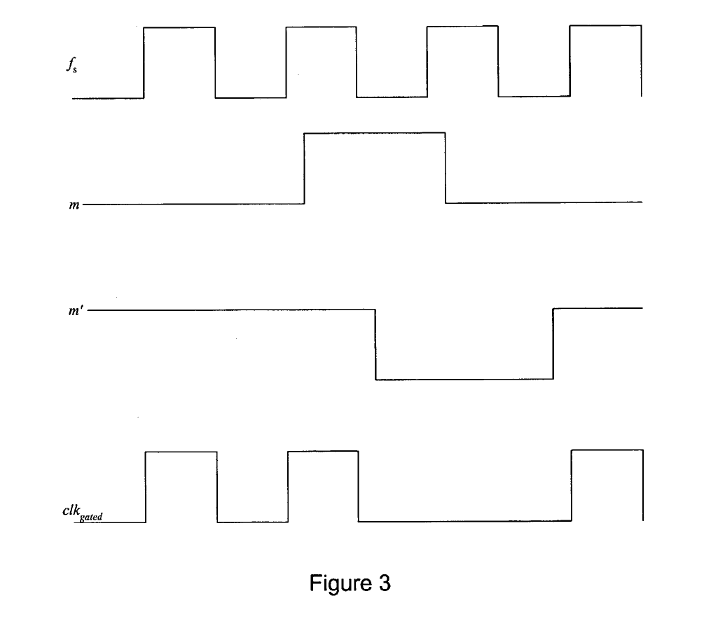

In this architecture the ADC 108 is driven by a free running clock 128 with a frequency slightly higher than the minimum two samples per symbol. The timing recovery (TR) loop 130 maintains phase lock and generates same number of timing ticks as the transmitter clock, resulting in the proper bit transmission from transmitter to receiver. TR loop achieves this by counting the ticks of ADC sampling clock and dropping the ticks as per control mₖ from timing processor derived in feedback manner. Control mₖ is a Boolean signal having value either 0 or 1. A tick of sampling clock is dropped when mₖ is 1. Hence this implementation can generate a clock at two times the symbol rate, phase locked to the transmitter as shown in the diagram. This recovered clock is denoted as the Gated Clock further in this document. The interaction of mₖ with the other timing signals is illustrated in FIG. 3.

Although phase locked to transmitter symbol clock, as we will discuss below, this Gated Clock is not suitable for uplink frequency reference, without further processing. This is due to the presence of high jitter and sidebands and which need to be reduced.

The control mₖ takes the value 0 or 1 as per underflow taking place in the NCO sitting inside the timing processor block. Had there been controlled sampling a sampling clock tick would have occurred at t=kTᵢ=(mₖ+μₖ)Tₛ. But this underflow is detectable only at next sampling clock tick at time t=(mₖ+1)Tₛ, which is (1−μₖ)Tₛ later in this case. Since μₖ is time varying, the timing of the mₖ also varies. Output timing (edges of mₖ in this case) from the receiver therefore exhibits a timing jitter with peak to peak amplitude of Tₛ even if the sampling clock and incoming data stream are entirely jitter free. Situation is more serious if the sampling interval Tₛ is a sizeable portion of the symbol interval T, a situation that invariably arises if the demodulator is designed to minimize sampling rate as in our case. Thus, the output f=2f_{sym} is a sufficiently accurate extracted clock that suffers from jitter. Jitter in this signal is due to the all digital derivation of the clock based on a received analog signal. A process for cleaning jitter from the derived gated clock signal will now be discussed.

Assuming an ADC sampling frequency of fₛ=2f_{sym}+Δf it is clear that a fundamental component in mₖ will be Δf. Gating of these two clocks will generate the following components: 2fₛ, 2(f_{sym}+Δf) along with harmonics of these components. Hence 2f_{sym}, the required component, is separated only by 2Δf from an equal power component at 2(f_{sym}+Δf). This component needs to be suppressed for Gated Clock to be used as a frequency reference.

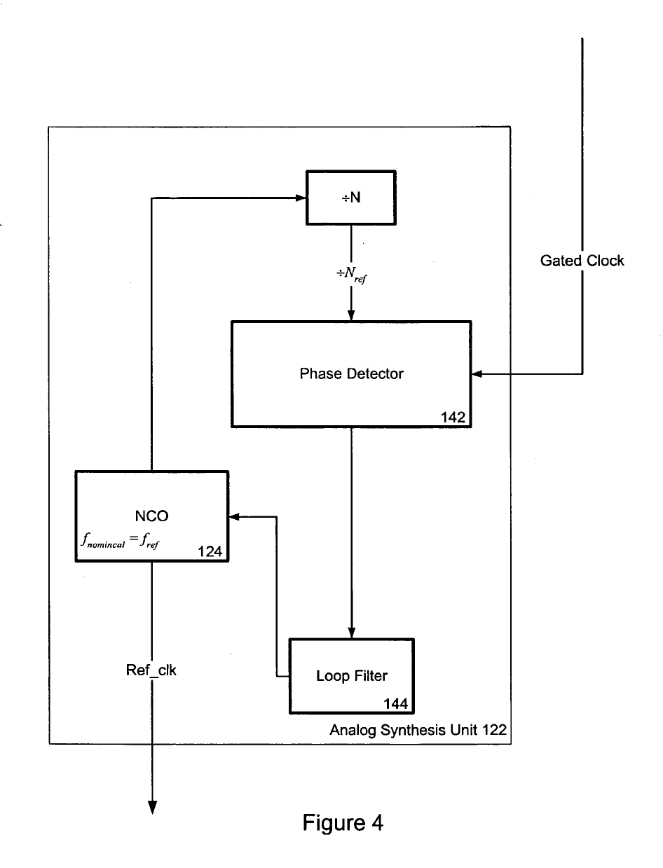

One way to reduce jitter and suppress side bands is to use a narrow band Phase Locked Loop (PLL). This narrow band PLL, which was previously described as an analog synthesis unit 122 employs elastic first-in first out (FIFO) buffer as phase a detector. As shown in the FIG. 4, it consist of a numerically controlled oscillator (NCO) 124 running nominally at f_{ref}, a phase detector 142 and a loop filter 144. Driving clock for the NCO 140 is derived from the same reference which is used for generating ADC 108 sampling clock. Gated Clock is divided down to f_{ref} and smoothing PLL 146 is locked to extract f_{ref}.

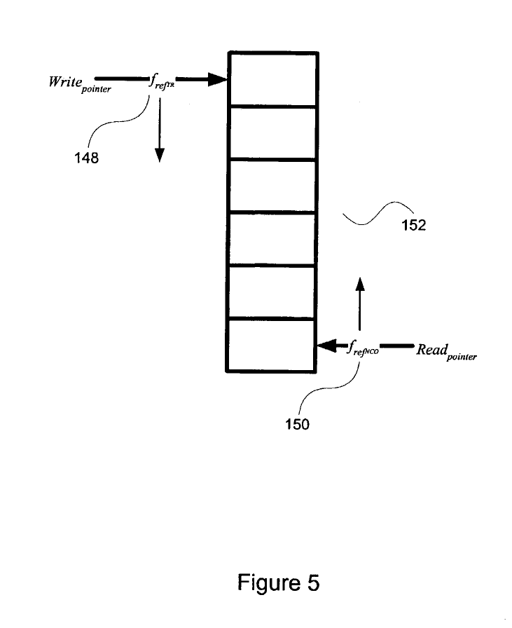

The phase detector 142 used here preferably employs same principle as the detectors employed in jitter removing PLL loops in digital telephone systems. Only difference is that the FIFO buffer used here does not store or serve data, and instead, only reads and writes pointer moves in opposing directions. Phase detector 142 includes a circular array 152. Two pointers, a read and a write pointer, are maintained. As represented in FIG. 5, the write pointer moves down 148 one increment for each tick in the jitter filled gated clock signal f_{ref}_{_{TR}}, while the read pointer moves up 150 one increment for each tick in the smoothed clock signal \overline{f}_{re\overline{f}}_{_{NCO}}. An error signal is derived by subtracting the values of the read and write pointers. By populating circular array 152 with data derived from determined systematic values the error signal provided to the loop filter 144 can be controlled to meet system requirements.

In the analysis of the system, the following notation is used to designate

P₁=Address of Write pointer for the linearly addressed FIFO

P₂=Address of Read pointer for the linearly addressed FIFO

error=P₁−P₂

A loop filter 144 is employed in the first order recursive filter given by following equation

e(n)=−a₁e(n−1)+bₒerror(n)+b₁error(n−1)

where the associated Z domain transfer function is given by

$$F ( z ) = \frac{{b}_{o} + {bz}^{- 1}}{1 + {a}_{1} {z}^{- 1}}$$

and where, filter coefficients are given by

$$\begin{matrix}{a}_{1} = - 1 \\ {b}_{0} = \frac{T}{2 {τ}_{1}} [ 1 + \frac{1}{tan ( \frac{T}{2 {τ}_{1}} )} ] \\ {b}_{1} = \frac{T}{2 {τ}_{2}} [ 1 + \frac{1}{tan ( \frac{T}{2 {τ}_{2}} )} ]\end{matrix}$$

where,

T=Sampling interval.

$$\frac{1}{{τ}_{1}} = First Corner Frequency in the Bode plot of equivalent F ( s )$$

$$\frac{1}{{τ}_{2}} = First Corner Frequency in the Bode plot of equivalent F ( s )$$

Operation of a presently preferred NCO 140 is described by the following equation

$$φ ( n ) = φ ( n - 1 ) + 2 {π}_{ref} {nT}_{s} + {K}_{o} e ( n )$$

$$if φ ( n ) > π$$

$$φ ( n ) = φ ( n ) - 2 π$$

$$end$$

$$if φ ( n ) <= - π$$

φ(n)=φ(n)+2π

end

Kₒ=NCO gain parameter

Tₛ=Period of clock driving NCO.

A fill point of 50% is designated as zero error while any other fill represents a non-zero phase error. The difference in the position of these two pointers becomes the error signal. This error value is processed by loop filter 144 and used to adjust the frequency of NCO 140 so as to drive the error towards zero. Output of the oscillator 140 constitutes smoothed clock which can be used for up-link frequency reference.

This results in an output signal that is largely free of the sidebands and jitter that made the Gated Clock originally unsuitable for use as the uplink frequency reference.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method of extracting a reference clock signal from a received analog signal, the method comprising:
digitising the received analog signal with a sampling rate determined by a sampling clock signal;
recovering timing signals from the digitised signal to produce a sample skipping signal;
gating the sample skipping signal with the sample clock signal;
generating the reference clock signal through analog synthesis of the gated signals.

2. The method of claim 1, further including the step of filtering the digitised signal prior to recovering the timing signals.

3. The method of claim 2, wherein the step of filtering includes applying a square-root-raised-cosine filter to the digitised signal.

4. The method of claim 1, further including the step of digitally cleaning the generated reference clock signal to remove jitter.

5. The method of step 4, wherein the step of digitally cleaning includes:
determining an error signal representative of the digitally determined phase difference between a controlled clock signal and the generated reference clock signal; and
adjusting an oscillator controlling the controlled clock signal to reduce the phase difference between the controlled clock signal and the received clock signal without introducing jitter in the controlled signal; and
providing the controlled clock signal as the extracted reference clock signal.

6. The method of step 5, wherein the step of determining an error signal further includes:
incrementing the position of a write pointer in a circular array with every tick of the generated reference clock signal;
decrementing the position of a read pointer in a circular array with every tick of the controlled clock signal; and
generating the error signal based on the difference in the read and write pointers.

7. A clock signal extractor, for receiving an analog signal from a remote station and generating a reference clock signal representative of the clock of the remote station, the extractor comprising:
a sampling clock, for generating a sampling clock signal;
a digitiser, for receiving the analog signal from the remote station and digitising it at a sampling rate determined by the sampling clock signal;
a timing symbol recovery unit, for receiving the digitised signal and for generating a sample skipping signal based on the digitised signal;
a gate for gating the sample skipping signal and the sampling clock signal; and
an analog synthesis unit for generating the reference clock signal based on the gated signal.

8. The extractor of claim 7 further including a filter for receiving the digitised signal, and providing the timing symbol recovery unit with a filtered digitised signal.

9. The extractor of claim 8, wherein the filter is a square root raised cosine filter.

10. The extractor of claim 7, wherein the analog synthesis unit includes:
a phase detector for detecting the phase difference between the gated signal and a reference signal produced by a controlled oscillator, and for deriving an error signal representative of the difference;
a filter, for receiving the error signal from the phase detector, and adjusting the controlled oscillator to reduce the difference between the gated signal and the reference signal; and
the oscillator, for providing the reference signal as the extracted clock reference signal.

11. The extractor of claim 10, wherein the oscillator is a numerically controlled oscillator.
